(19) United States
(12) Patent Application Publication
(10) Pub. No.: US 2017/0301316 A1
(43) Pub. Date: Oct. 19, 2017

(54) MULTI-PATH GRAPHICS RENDERING

(71) Applicant: James Paul Farell, Canton, MI (US)

(72) Inventor: James Paul Farell, Canton, MI (US)

(21) Appl. No.: 15/097,989

(22) Filed: Apr. 13, 2016

(51) Int. Cl. G09G 5/36; G06F 3/048; G06F 3/041

(52) U.S. Cl. CPC G09G 5/363; G06F 3/041; G06F 3/048

(57) ABSTRACT

Systems, methods, and displays are disclosed herein for multi-path graphics rendering. The aspects disclosed herein disclose a brute force learning technique to create a data set for correlating images to an optimal rendering technique. Other aspects disclosed herein disclosed employing the created data set for rendering and display the image data. Also provided herein are display devices configured and capable of employing the systems and methods disclosed herein.

### BACKGROUND

Digital displays provide a medium in which lighted elements are employed to convey information to a viewer of the digital display. The digital displays may be employed in a variety of contexts and environment, such as a personal computer, a home, a vehicle, or the like.

The digital display may be coupled to a control system, such as a processor and the like. The control system may receive instructions or information to convey via the digital display. The control system may be configured to translate (or render) the information onto the digital display.

The architecture of a sample digital display system and the electrical componentry to control and modify a digital display is shown below in FIG. 1. The system shown is exemplary and is used to illustrate a model form of implementing a display system.

As shown in FIG. 1, a display 150 is provided that displays images, such as image 151. The original data from the image is received from a source, for example a data store 110. The data store 110 may be a local or network provided storage device that provides data of text, images, or videos to be provided via display 150.

The image data 120 (sourced from the data store 110) is communicated to a microprocessor 130. Alternatively, the microprocessor may receive a signal or generate a signal requesting image of a specific type. Thus, image data 120 may be provided in response to a request generated by the microprocessor 130.

After the image data 120 is received, the microprocessor 130 may receive a rendering technique 131 from another data store (or from an internal memory storage embedded in the microprocessor 130). The rendering technique 131 may be applied to the image data 120 and produce rendered data 132. The rendered data 132 is inputted into a display driver, which produces display data 142 to show on the display 150\. The display data 142 may be converted to various pixels and other data types based on the display 150's technology and capabilities.

Various examples of rendering techniques are described below. The list is meant to be exemplary, and is not an exhaustive list of all rendering techniques capable of being employed with the various aspects disclosed herein.

For example, some of the rendering techniques employable are a Open VG GPU, a Open GL GPU, a non-standard GPU, a Sprite engine, a BIT-BLTer, and use of a CPU.

Previously, a system was likely to have only one rendering technique available. However, in recent times, systems may be capable of employing more than one rendering technique. This leads to several difficulties, one of which being optimizing a performance on the display 150 using the lowest cost microprocessor (130) possible.

Various elements need to be optimized in order to provide a desired output, such as the frame rate, the maximum amount of RAM or flash memory available, and the like. However, these elements may differ based on the hardware provided. Thus, implementing a system shown in FIG. 1 with multiple rendering techniques may be difficult.

### SUMMARY

The following description relates to a multi-path graphics rendering. Exemplary embodiments may also be directed to the systems and methods for employing the rendering, and display devices incorporating said concepts.

In one of the systems disclosed herein, the system includes an application receiver configured to receive the application; a brute force learner configured to identify a plurality of images associated with the application, render each of the plurality of images with more than one image rendering technique, and to assign a score for each of the plurality of images applied to each image rendering technique based on a plurality of criteria associated with image presentation; and a data set creator configured to assign each of the plurality of images with the image rendering technique associated a highest score.

In another example of the system, each of the plurality of criteria is assigned a specific weight, with the specific weights being employed to calculate the score.

In another example of the system, the brute force learner is configured to perform on all of the images associated with the application.

In another example of the system, the system is embedded on a processor, the processor including a plurality of rendering techniques associated with rendering each of the plurality of images.

In another example of the system, one of the plurality of criteria is associated with memory usage.

In another example of the system, one of the plurality of criteria is associated with a speed associated with an image rendering.

In another one of the systems disclosed herein, the system includes an image analyzer to receive image data from the processor; a rendering retriever to correlate the received image data with the created data set, and to retrieve a rendering technique previously assigned to the received image data; and a rendering communication configured to communicate the retrieved rendering technique to the microprocessor.

In another example of the above system, the system is embedded on the microprocessor.

In another example of the above system, the application is defined as multiple applications.

Also provided herein is a display device. The display device includes in part an electrical coupling to a microprocessor; a plurality of rendering techniques associated with a display driver, wherein in response to the microprocessor communicating image data to the display driver, a rendering technique of the plurality of rendering techniques is selected based on a previously assignment.

In another example of the display, the previous assignment is defined by a brute force learning process performed iteratively for every image of an application being executed on the microprocessor.

In another example of the display, the rendering technique associated with a least usage of available random access memory (RAM) is chosen for the communicated image data.

In another example of the display, the rendering technique associated with a least usage of available non-volatile memory is chosen for the communicated image data.

In another example of the display, the rendering technique associated with a lowest frame rate is chosen for the communicated image data.

In another example of the display, the rendering technique associated with a weight score based on the lowest frame rate, lowest RAM usage, and lowest flash memory usage is chosen for the communicated image data.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 illustrates an example of a display system of the prior art.

FIG. 2 illustrates an example of a system for creating a data set associated with the aspects disclosed herein.

FIG. 3 illustrates an example of a method explaining the operation of FIG. 2.

FIGS. 4(a)-(c) illustrate examples of the analysis performed in accordance with an execution of the system in FIG. 2.

FIG. 5 illustrates an example of a system for employing a created data set in an operation of rendering images according to the aspects disclosed herein.

FIG. 6 illustrates an example of a method explaining the operation of FIG. 5.

FIGS. 7(a) and (b) illustrate an example of a display employing the aspects disclosed herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As explained in the Background section, providing a display technology capable of employing multiple rendering techniques may be difficult. For example, when multiple rendering techniques are employed, the various control logic and driving technologies may be incapable of providing an optimal experience for the available hardware and resources installed.

Disclosed herein are methods and systems for displaying data employing a learning process. The aspects disclosed herein employ various techniques, such as brute force learning, to create a data set associated with images associated with a system and/or application, to provide a display based on the created data set.

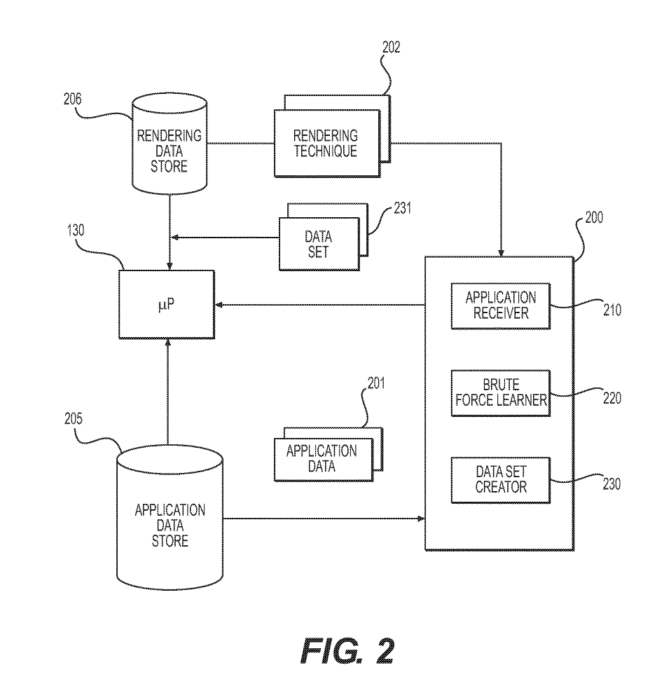

FIG. 2 illustrates an example of a system 200 for creating a data set associated with the aspects disclosed herein. The system 200 may be employed prior to or any time a display system 150 is implemented with application data 201. The system 200 includes an application receiver 210, a brute force learner 220, and a data set creator 230.

The application data 201 (which may be sourced from an application data store 205) represents a program (or set of programs) that is/are executed on a microprocessor 130. The programs may be any sort of program associated with the operation of microprocessor 130, such as entertainment programs, vehicle operation programs, telemetry, and the like.

The application data 201 contains a set of images associated with the application (or multiple applications). The set of images may be multiple image files (such as those explained above with regards to image data 120). Each image file is a distinct and discrete representation of a screen or graphical user interface (GUI) seen by a viewer of display 150.

The application receiver 210 receives the application data 201, and parses all the available images associated with the application data. Thus, each image is separated and created into a data set of all available images. In another example of an implementation of system 200, a subset of the available images may be parsed.

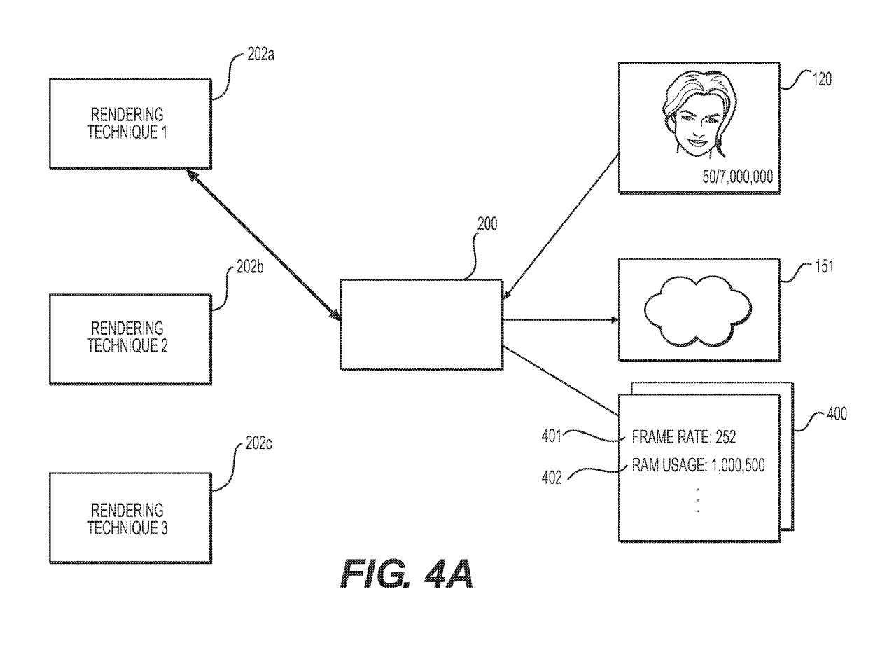

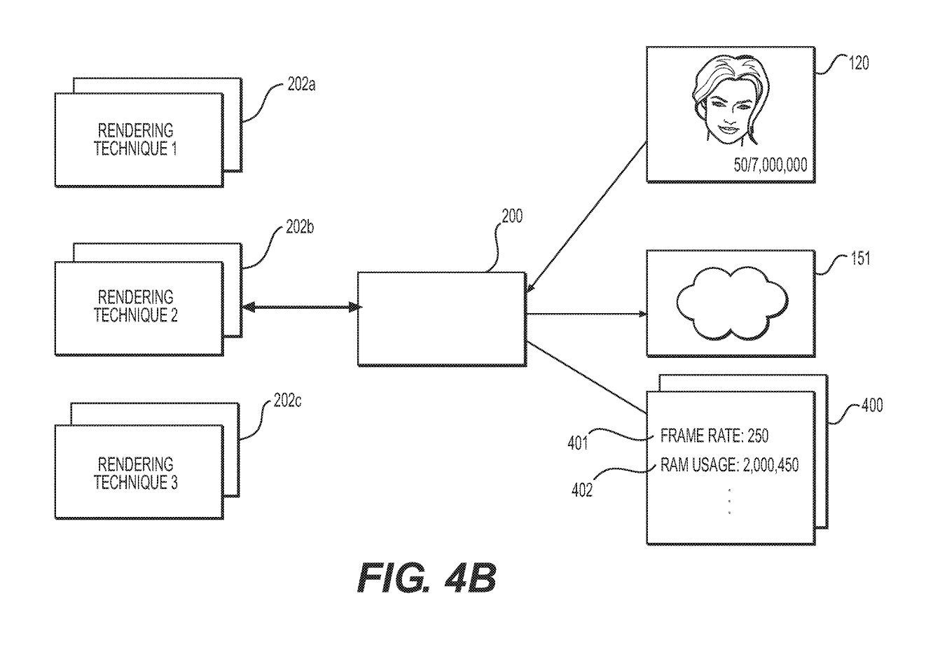

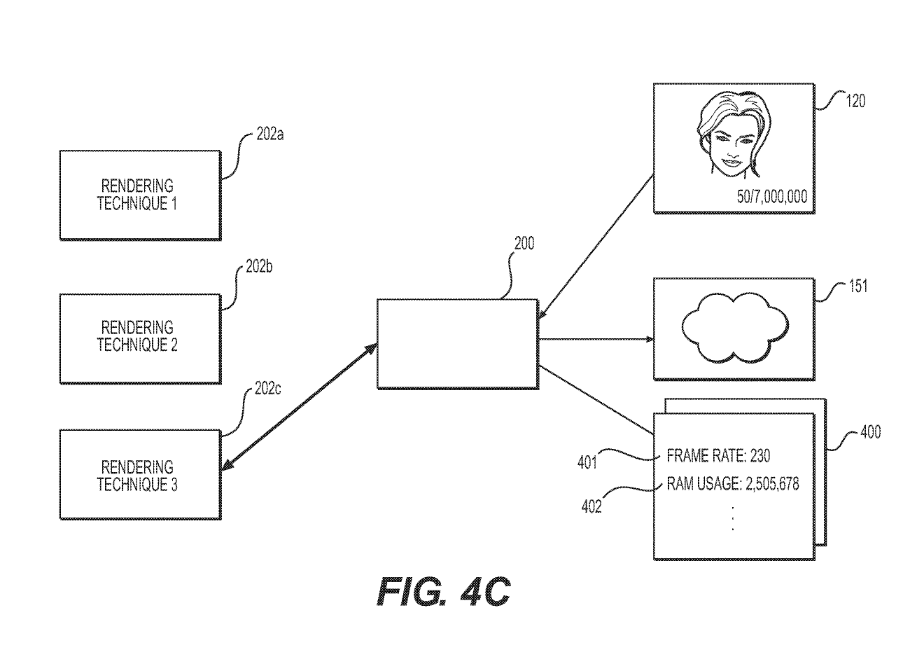

The brute force learner 220 is configured to analyze each image individually. Several examples of the analysis are shown in FIGS. 4(a)-(c). Each individual image parsed via the application receiver 210 is measured for its performance with the various rendering techniques 202 available.

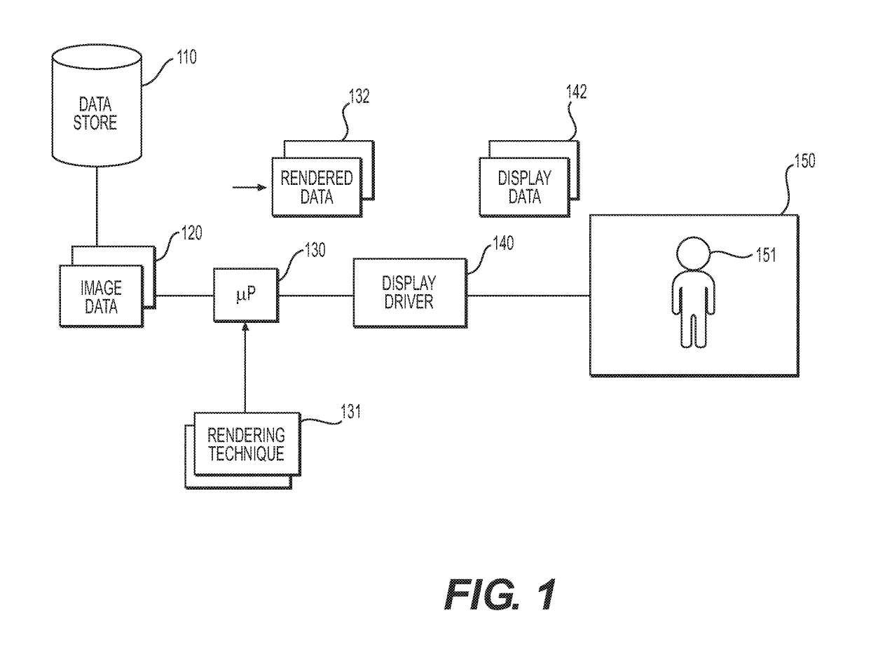

As shown in FIG. 2, the microprocessor 130 may also be provided with a rendering data store 206. The rendering data store 206 stores data associated with each of the plurality of available rendering techniques 202. Each rendering technique 202 may be applied to each individual image associated with the image data 120 included in the application data 201. As explained in FIG. 1, the microprocessor 130 employs a specific rendering technique with each of the images processed by the microprocessor 130 and communicated to the display driver 140 to display on the display 150.

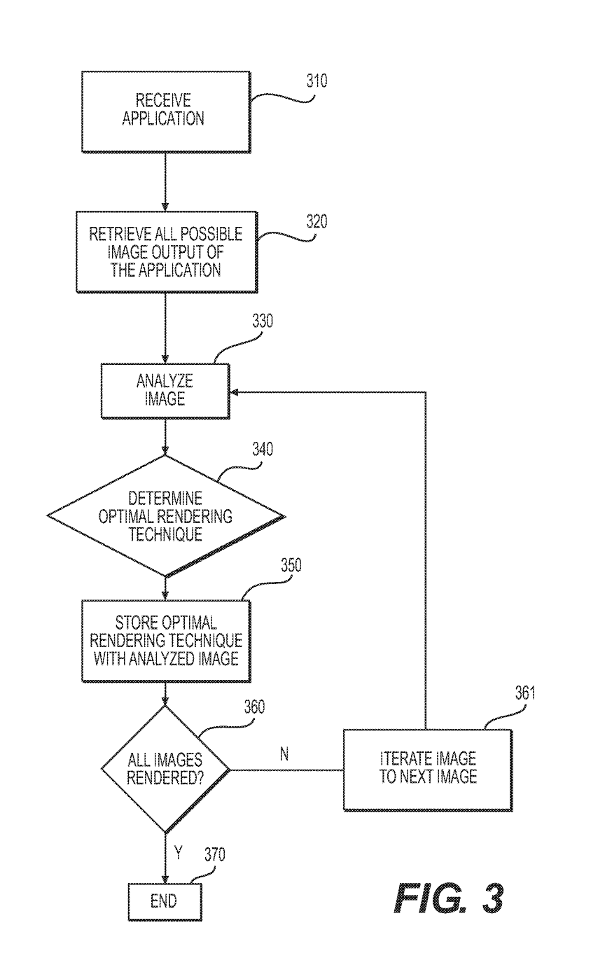

The brute force learner 220's operation is detailed in FIG. 3, and specifically from operations 330 and on. Each of the images associated with the application data 201 is tested for each of the available rendering techniques 202.

In FIG. 3, the method 300 includes an operation of retrieving an application to analyze (operation 310). From operation 310, the method proceeds to operation 320, where all, some (i.e. a predetermined set) of images associated with the execution of the application is retrieved.

From operation 330 to the end 370 of method 300, an iterative process for each of the images retrieved in operation 320 is performed.

In operation 330, the image is analyzed with all available rendering techniques. As show in FIGS. 4(a)-(c), a sample set of rendering techniques 202a, 202b, and 203c are provided. In FIG. 4(a), the image 120 is rendered via rendering technique 202a, with data 400 being created. Data 400 includes a frame rate 401 and a RAM usage 402. Other performance metrics that may be employed are: CPU utilization, flash memory size required, and Data bus utilization. The implementer of system 200 may choose which combinations of performance metrics associated with graphical displays/image rendering may be used.

As shown in the progression of FIGS. 4(a) to (c), each of the rendering techniques are individually applied to the image data 120, with each of the techniques producing a rendered image 151. The value for each rendering technique is stored, and for each individual image, an optimal rendering technique is determined.

To determine an optimal rendering technique, each of the tested quantities in data set 400 is provided a score (operation 340). Each metric (for example, metric 401 and 402) are then assigned a weight. Thus, the rendering technique with the best score is then chosen for the image. The optimal rendering technique is stored with an index pointing the respective image (operation 350).

For example, the following relationship may be used:

Weighting for the frame rate->W1;

Weighting for the RAM usage->W2;

Normalized_Frame_Rate=Measured Frame Rate 401/260;and

Normalized_RAM usage=Measured RAM usage/2,000,000;

Score=W1*Normalized_Frame_Rate+W2*Normalized_RAM_USAGE

The equation and the number above are exemplary. They merely are shown that the method 300 and system 200 may be configured by an implementer with different weights and/or measured quantities associated with the choosing of which images to provide.

As explained above, this process is iterative, with the iterative determination being performed in operations 360 and 361. All the images undergo the analysis described above, with the conclusion being that a data set 231 is created with each image being associated with a specific rendering type (data set creator 230).

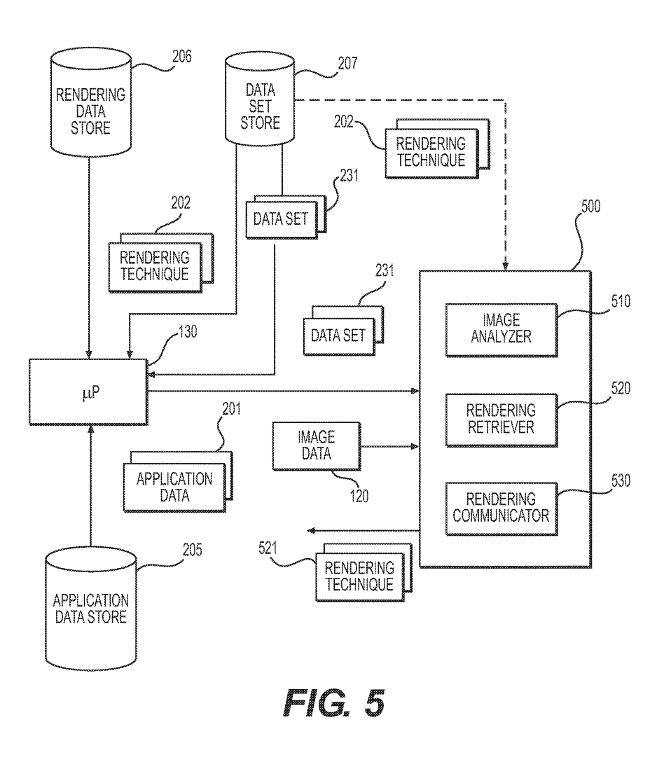

FIG. 5 illustrates an example of a system 500 for employing a data set for image rendering according to the aspects disclosed herein. The system 500 may be employed on a processor, such as a graphical processing unit (GPU) or the like. As shown, the microprocessor 130 is also provided. The microprocessor 130 may be hardwired or encoded to operate in a manner capable of implementing system 500 (or method 600). The system 500 includes an image analyzer 510, a rendering retriever 520, and a rendering communicator 530.

The application data store 205 and the rendering data store 206 are similar to the ones explained above. The microprocessor 130 is configured to retrieve a rendering type based on a request associated with the application. The microprocessor 130 may instigate an execution of an application 201, which is retrieved from the application data store 205. Once the microprocessor 130 retrieves the application data 201, the microprocessor 130 may interface with system 500 to determine which rendering techniques to employ with each of the individual image data being provided on a display 150 (not shown in FIG. 5).

For example, in the process of running the application data 201, an image data 120 may be buffered to be displayed. The system 500 may retrieve the image data 120, the data set 231 and analyze the image data 120 to determine which rendering technique to employ with the rendering of image data 120. The image analyzer 510 may be configured to analyze the image for this specific correlation. Once the rendering technique is chosen, the rendering retriever 520 may retrieve the rendering technique 202 (for example, which may be any of rendering technique 202a, 202b, or 202c), and communicate the rendering technique to the microprocessor 130 (via rendering communicator 530).

In another example implementation of system 500, the system 500 may be configured to communicate an indication of which rendering technique 202 is to be used.

Concurrently, prior, or after receiving the image data 120, the data set 231 may be retrieved as well. As explained above, the data set 231 is a data table that indicates which rendering technique 202 is to be applied to the specific image data 120. As explained above, when system 200 or method 300 is executed, each image data 120 is associated with a specific or optimal rendering technique 202.

The rendering retriever 520 is configured to analyze the received data set 231, and retrieve the rendering technique 521 associated with the received image data 120. The rendering communicator 530 then subsequently communicates the rendering technique 521 to the microprocessor.

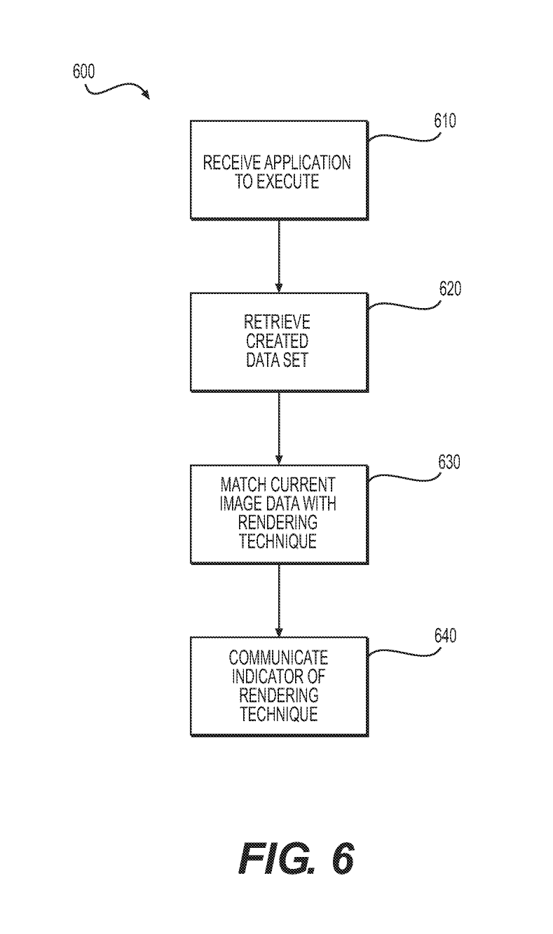

FIG. 6 illustrates an example of a method 600 illustrating the elements of system 500.

In operation 610, an application being executed on the microprocessor is received. For example, the application may be associated with the application referenced in FIGS. 2 and 3.

In operation 620, a created data set associated with the application is retrieved. The creation of the data set is explained in greater detail with the explanation of FIGS. 2 and 3. Thus, the created data set includes a listing of some or all of the images associated with the application, and a correlated rendering technique to be employed.

In operation 630, the presently to be displayed images are matched with a rendering technique based on data stored in the correlated rendering technique. For example, if the microprocessor, via the application, is queued to render a specific image data, the rendering technique to be used may be retrieved from the created data set.

In operation 640, the rendering technique selected to be used for a specific image is communicated to a microprocessor and/or display driver.

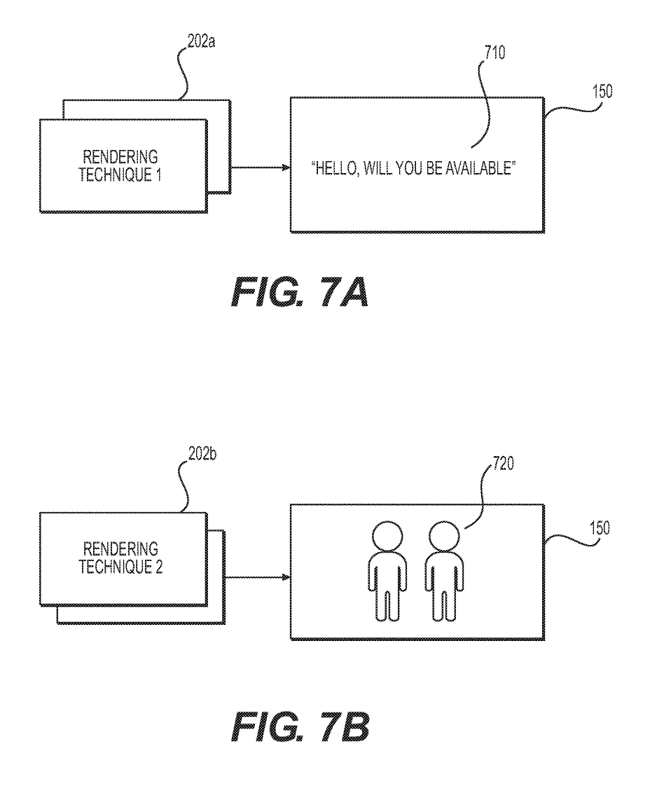

To further illustrate this example, FIGS. 7(a) and (b) are presented. As show in FIG. 7(a), an image 710 with mostly text is presented on a display 150. In FIG. 7(b), an image 720 with mostly figures is presented on the display 150. Employing the aspects disclosed herein, a score may determine that text based images are preferable with a rendering technique 1 (202a), while graphics/figure based images are preferable with a rendering technique 2 (202b).

As such, employing both systems 200 and 400, a rendering technique 1 (202a) is selected for image 710 while a rendering technique 2 (202b) is selected for an image 720.

Thus, the aspects disclosed above are employed prior to the execution and running of an application. The application may be provided with a learning process, where the application is run with system 200 to generate a data set 231 that assigns a specific rendering technique to each image associated with the execution of the application data 201. As such, a system that employs numerous graphic rendering techniques (such as those described above or known in the art), may provide an optimal image presentation based on a learn-in process performed prior to an execution of an application. FIGS. 5, 6, and 7(a)-(b) illustrate an example implementation of a system and method for employing a created data set with an optimal association between each image and its automatically selected rendering technique.

Certain of the devices shown in FIG. 1 include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIGS. 3 and 6. The disclosed devices, components, and systems contemplate using or implementing any suitable technique for performing the steps illustrated in these figures. Thus, FIGS. 3 and 6 are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for creating a data set associated with an application's image rendering, comprising:
an application receiver configured to receive the application;
a brute force learner configured to identify a plurality of images associated with the application, render each of the plurality of images with more than one image rendering technique, and to assign a score for each of the plurality of images applied to each image rendering technique based on a plurality of criteria associated with image presentation; and
a data set creator configured to assign each of the plurality of images with the image rendering technique associated a highest score.

2. The system of claim 1, wherein each of the plurality of criteria is assigned a specific weight, with the specific weights being employed to calculate the score.

3. The system of claim 1, wherein the brute force learner is configured to perform on all of the images associated with the application.

4. The system of claim 1, wherein the system is embedded on a processor, the processor including a plurality of rendering techniques associated with rendering each of the plurality of images.

5. The system to claim 1, wherein one of the plurality of criteria is associated with memory usage.

6. The system according to claim 1, wherein one of the plurality of criteria is associated with a speed associated with an image rendering.

7. A system for employing a created data set with correlations of a rendering technique with a set of images associated with an application executed on a microprocessor, comprising:
an image analyzer to receive image data from the processor;
a rendering retriever to correlate the received image data with the created data set, and to retrieve a rendering technique previously assigned to the received image data; and
a rendering communication configured to communicate the retrieved rendering technique to the microprocessor.

8. The system of claim 7, wherein the system is embedded on the microprocessor.

9. The system of claim 7, wherein the application is defined as multiple applications.

10. A display, comprising:
an electrical coupling to a microprocessor;
a plurality of rendering techniques associated with a display driver, wherein in response to the microprocessor communicating image data to the display driver, a rendering technique of the plurality of rendering techniques is selected based on a previously assignment.

11. The display of claim 10, wherein the previous assignment is defined by a brute force learning process performed iteratively for every image of an application being executed on the microprocessor.

12. The display of claim 10, wherein the rendering technique associated with a least usage of available random access memory (RAM) is chosen for the communicated image data.

13. The display of claim 10, wherein the rendering technique associated with a least usage of available non-volatile memory is chosen for the communicated image data.

14. The display of claim 10, wherein the rendering technique associated with a lowest frame rate is chosen for the communicated image data.

15. The display of claim 10, wherein the rendering technique associated with a weight score based on the lowest frame rate, lowest RAM usage, and lowest flash memory usage is chosen for the communicated image data.
